(19) United States
(12) Patent Application Publication
(10) Pub. No.: US 2002/0000176 A1
(43) Pub. Date: Jan. 3, 2002

(54) Capsule sealing system

(76) Inventor: Victor Morrison Young, South Queensferry (GB)

Correspondence Address: FLESHNER & KIM, LLP, P.O. Box 221200, Chantilly, VA, 20153-1200, US

(21) Appl. No.: 09/819,606

(22) Filed: Mar. 29, 2001

Related U.S. Application Data
(63) Continuation-in-part of application No. 09/346,222, filed on Jul. 1, 1999, now abandoned.

(30) Foreign Application Priority Data
Jul. 3, 1998 (GB) 9814411.6

(51) Int. Cl. C09D 4/00

(52) U.S. Cl. 106/194.2

(57) ABSTRACT

A sealant solution for sealing capsules comprises a mixture of HPMC and a solute which elevates the thermal gelation temperature of the HPMC, and also a mixture of a gelling agent and a hydrolysing agent, wherein said hydrolysing agent decreases the solution temperature of said gelling agent. The sealant solution is produced by mixing a first subordinate solution, which contains the HPMC and solute, and a second subordinate solution, which contains the gelling agent and the hydrolysing agent, the first and second subordinate solutions being heated before mixing.

This invention relates to a capsule sealing solution and system especially but not exclusively for use with non-gelatin capsules primarily composed of hydroxpropylmethylcellulose (HPMC).

Capsules are one of the major dosage forms for medicinal and health food products. Many capsules are made from gelatin, a natural product typically obtained by controlled hydrolysis from the fibrous insoluble protein collagen, which is widely found in nature being the major constituent of skin, bones and connective tissue. Pigs and cattle are commonly used as the major source of this material. However, public concern over BSE and other animal related diseases, coupled with religious beliefs and vegetarianism has resulted in increasing problems being encountered regarding the use of gelatin in the formation of capsules.

In order to retain liquids and semi-solids, gelatin capsules are sealed by applying a band of hot gelatin solution to bridge the body and cap of a capsule. On drying, a tough leak-proof seal between the two halves of the capsule is formed.

Recent research into encapsulation of liquids and semi-solids has been targeted towards the development of capsules based on the use of hydroxypropylmethylcellulose (HPMC). Sealing systems for these capsules have been based on the use of HPMC solutions in water and at best have shown limited success.

The best type of solution for sealing a capsule is one based on the material from which the capsule is made. For example, the sealant for gelatin capsules is a gelatin/water mixture that is applied hot and sets (gels) on cooling.

It should therefore be possible to use an HPMC solution to seal a capsule. The use of a hot aqueous solution of HPMC is not possible due to the fact that such a solution gels on heating. Gelled solutions are not suitable for use as sealants. As HPMC solutions do not gel when cold, in theory they could be applied cold and subsequently dried.

However, on applying the sealant solution, the water contained in the solution is absorbed by the capsule shell weakening the shell to such an extent that it can be punctured; wet HPMC has little or no strength. The act of closing the cap results in a build up of pressure within the capsule, due to the presence of a gas space. This build up in pressure can cause the contents of the capsule to burst through the wall of a shell weakened by water.

Secondly, between the body and cap of the capsule there exists a space, which is filled with the aqueous sealing solution, the solution being drawn into this gap by capillary action. The gas in this gap, therefore, becomes pressurised and seeks a route out of the capsule. This is normally achieved by forcing a channel through the seal creating a gap in the seal.

It would therefore be desirable to be able to use an HPMC based sealant that will readily gel on application thus slowing absorption of water by the shell and preventing movement of the sealant between the two halves of the capsule by capillary action. The main problems that would require to be overcome as a result of the presence of HPMC include a possible lack of solubility of the gelling agents, and the fact that HPMC readily gels on elevation of temperature. It would therefore be desirable to achieve gelation of the solution on cooling.

Further requirements of materials to be used in the sealing solution include that they are compatible with the material of the shell, i.e. they can stick to the shell, and they are soluble in suitable solvents and that they produce tack free seals. The materials must also be acceptable to the customer and economical.

In the present Application, references to “thermal gelation temperature” refer to the temperature at which HPMC gels (comes out of solution). References to “solution temperature” refers to the temperature at which a gelling agent dissolves to form a solution.

HPMC based sealing solutions that gel on cooling are non known in the prior art.

All concentrations used in the present Application refer to the concentration in the final sealing solution.

It is an object of the present invention to provide a sealing mixture with the necessary properties to form a viable HPMC capsule sealing solution.

According to a first aspect of the present invention there is provided a sealant solution for sealing capsules, said sealant solution comprising a mixture of Hydroxypropylmethylcellulose (HPMC) and a solute, wherein the solute elevates the thermal gelation temperature of the HPMC, and wherein the sealant solution also comprises a mixture of gelling agent and hydrolysing agent, wherein said hydrolysing agent decreases the solution temperature of said gelling agent.

The presence of the solute and hydrolysing agent allows the HPMC and gelling agent to be retained and mixed in solution.

Preferably the grade of viscosity of the hydroxypropylmethylcellulose is not limited, Typically the viscosity grade is in the region of 6 cps at 2% concentration.

Preferably any suitable solute may be used to elevate the thermal gelation temperature of the HPMC. Typically the solute is an alcohol. Typically the alcohol is propan-1-ol or propan-2-ol.

Typically the concentration of alcohol by weight is greater than 10%.

Preferably the concentration of alcohol by weight is 20%

Preferably the gelling agent is comprised of one or more gums. Typically gellan gum is used.

Typically the concentration of gellan gum by weight is less than 0.15%.

Preferably the concentration of gellan gum by weight is 0.05%.

Preferably the hydrolysing agent is sodium citrate.

Optionally a plasticiser such as propylene glycol may be added to modify the properties of the seal.

According to a second aspect of the present invention there is provided a process for producing a sealant solution for sealing capsules comprising the stages of

a) mixing a first subordinate solution of HPMC and alcohol to form a solution wherein the alcohol elevates the thermal gelation temperature of the HPMC;

b) mixing a second subordinate solution of gelling agent and hydrolysing agent to form a solution wherein the hydrolysing agent promotes dissolution and inhibits gelation of the gelling agent;

c) mixing the two solutions together.

Preferably the first and second subordinate solutions are heated prior to and during mixing.

Most preferably the first and second subordinate solutions are heated to 50° C.

Preferably the alcohol is propan-1-ol or propan-2-ol.

Preferably the gelling agent is gellan gum.

Preferably the hydrolysing agent is sodium citrate.

Preferably the concentration of alcohol in the first subordinate solution, by weight is over 10%. Most preferably the concentration of alcohol is 20%.

Preferably the concentration of gelling agent in the second subordinate solution, by weight is less than 0.5%. Most preferably the concentration of gelling agent is 0.15%.

Optionally a plasticiser such as propylene glycol may be added to modify the properties of the seal.

According to a third aspect of the present invention there is provided the sealant solution of the first aspect manufactured by the process of the second aspect.

In order to provide a better understanding of the invention, an example of the invention will now be described, with reference to the accompanying Figure, which represents the process of making a sealing solution in accordance with the present invention.

This sealing solution of the present invention is a free flowing fluid that is designed to be usable in the 35° C. to 55° C. range and, after application dad drying, to form a firmly bonded tough seal on capsules. Between application and drying it is designed to gel lightly to prevent capillary action drawing the material into the void caused by the overlap between the capsule cap and body. Above 55° C. the sealing solution is typically unstable.

HPMC is soluble in cold water but gels (or sets) with temperature elevation. That is to say in hot water the HPMC will come out of solution. Typically for the low viscosity grades used for a sealing solution, this gelation temperature is of the order of 30° C. It will be appreciated that this gelation temperature is particularly low, and consequently it is difficult to use HPMC in a sealant solution in the same manner as gelation is used.

In the present invention, it is known that by using a relatively high concentration of alcohol such a propan-2-ol, added to the HPMC solution (which is used in a concentration of about 12.5%) or during its preparation, the HPMC can be kept in solution at higher temperatures. This high concentration of alcohol is thus used as part of the dissolution system. This is an essential aspect of the present invention as it elevates the thermal gelation temperature of the HPMC and, for the HPMC concentrations typically used, produces an HPMC solution that remains as a clear mobile fluid (i.e. does not gel) until 55° C. Above this temperature the HPMC solution gels.

A gelling agent is also used in the sealant solution as an additive to produce the lightly gelled intermediate stage in the sealing process. This is particularly important as the light gel consistency of the solution prevents it from being drawn into the gap between body and cap. Gellan gum is typically used as it is compatible with an HPMC solution and can be manipulated to form a light gel in its presence and within the desirable temperature range.

Gellan gum dissolves (hydrates) at 75° C. in deionised water. It therefore gels as the temperature is lowered, the converse of HPMC solutions. This hydration temperature is raised even further if any ions are present in the mixture. For example concentrations as low as 0.008% Ca²⁺ can raise the hydration temperature to in excess of 100° C. Thus, in normal conditions HPMC and gellan gum are in solution at different temperature ranges, and cannot be combined in solution. In order to lower the hydration temperature, to allow the HPMC-alcohol solution to be mixed with the gelling agent, a sequesterant is used, in the present invention. This is typically but not exclusively tri-sodium citrate. In deionised water this has been found to lower the hydration temperature to below 30° C. In assisting hydration of the Gellan gum, the sequesterant inhibits gel formation at low temperatures as would normally occur, keeping the gelling agent in solution several tens of degrees below the unsequestered gelation point. This allows the gellan gum to be kept in solution in a temperature range where the HPMC and high concentration alcohol is in solution.

Gellan gum, even with added sequesterant, does not hydrolyse (dissolve) in the presence of the typical concentrations of HPMC used in a sealing solution below temperatures of 55° C. as the HPMC typically releases ions into the solution. However, heating above this temperature causes the HPMC to gel.

Preparation of Gellan gum as a separate solution with added sequesterant and addition of this solution at a temperature of 40° C.-55° C. to an HPMC solution which is in solution at a similar temperature due to the presence of a high concentration of alcohol, results in a clear mobile solution in which neither the HPMC nor the Gellan gum gels within the temperature range of 35° C. to 55° C. This is the sealing solution.

A plasticiser such as polyethylene glycol or propylene glycol may be added to the HPMC primary solution to modify the properties of the end product that is the dry capsule seal. However a plasticiser is not essential and typically is not used.

An example of the formulation of a typical quantity of sealing solution is shown in FIG. 1 +L.

| Materials | Weight |
|---|---|
| HPMC solution (Solution 1) | |
| Pharmacoat 606 | 250 g |
| Propan-2-ol | 400 g |
| Water | 950 g |
| Gellan gum solution | |
| (Solution 2) | |
| Gellan gum | 3 g |
| Tri-sodium citrate | 0.4 g |
| Water | 397 g |

### FIG. 1 +L. Formulation of Sealant Solution

All concentrations used in the present Application refer to the concentration in the final sealing solution.

Pharmacoat 606 is a substitution type 2910 pharmacopoeial grade HPMC made by Shin Etsu Chemical Co of Tokyo, Japan. This is a low viscosity grade with a USP or EP apparent viscosity of 4.8-7.2 cps. HPMC is soluble in cold water but gels with temperature elevation. Typically for the low viscosity grades used of a sealing solution, this gelation temperature is of the order of 30° C. It functions as the solid film forming material in the end product, the dry capsule seal in this embodiment.

Gellan gum is a naturally derived polysaccharide produced by NeutraSweet Kelco, a Monsanto company, and provided under the trade name of Kelcogel. This is a food grade material used in the food industry as a gel forming agent or thickener. This material is typically used at a level of 0.05% up to a maximum of <0.5% in the final mixed solution. This concentration is required to be kept below 0.5% as the function of the gellan gum material is to form a light gel to hold the sealing material in place and prevent capillary action until the sealing mix has dried and formed a rigid seal, and not a proper firm gel which would be achieved from a higher concentration of gum.

Propan-2-ol is BP grade material, and is used as a means of elevating the thermal gelation temperature of HPMC in solution. Typically the content of alcohol in the final mixed solutions is 20%, although thermal gelation temperature can be elevated using an alcohol content as low as 10%.

The final sealing solution is prepared by heating both the above solutions separately until they reach approximately 50° C. and all materials are in solution. It is only possible to obtain both materials in solution at this temperature by mixing the HPMC with high concentration alcohol to keep the HPMC in solution at a higher temperature than normal, and separately mixing the gelling agent with a sequesterant such as sodium citrate to keep the gelling agent in solution at a lower temperature than normal. Pictorially, this can be seen in FIG. 1 where Flask 1 contains the HPMC with alcohol which elevates the gelling temperature of said HPMC, and Flask 2 contains the gelling agent (typically, Gellan Gum) with Sodium Citrate. Both the solutions are separately heated to a suitable temperature, which will typically be in the region of 50° C., on standard stirrer hotplates 6 or by other suitable means. The high level of alcohol in Flask 1 raises the solution temperature of the HPMC up whilst the Sodium Citrate in Flask 2 brings the minimum solution temperature of the Gellan Gum down, until the temperature at which the HPMC and Gellan Gum are in solution overlaps, at which time the two solutions can be mixed.

Once the materials are in solution, they are mixed to produce a clear mobile solution, suitable for use with standard capsule sealing (banding) equipment. The final solution is used to seal capsules using techniques known to persons skilled in the art. The solution must be held in the temperature range of 35° C. to 55° C. during storage and use. Above 55° C. the sealant solution is unstable.

Because a low concentration of gelling agent is used (at least less than 0.5%, typically 0.15% by weight) the sealant solution will, at its working temperature (35 to 55° C.), form a light gel after application which holds the sealant in place and prevents capillary action until dried. It will be appreciated however that as the concentration of gelling agent is low, the gel will be light in consistency.

An advantage of the present invention is that there is provided an alternative gelling capsule sealing solution based on HPMC which is free flowing, and after application and drying forms a firmly bonded tough seal on capsules. A particular advantage is the fact that between application and drying the sealing solution gels lightly to prevent capillary action drawing the material into the void caused by the overlap between the capsule cap and body.

A further advantage is that the sealing solution is based on the use of cheap materials The process for making the solutions is also simple and economical using equipment that is currently in use.

The present invention also solves the problem of using (and mixing) HPMC which is typically only in solution at very low temperatures and gels at a temperature of around 30° C., combined with a gelling agent such as gellan gum which will only dissolve an very high temperatures, (and even higher temperatures in the presence of ions).

Further modifications and improvements may be added without departing from the scope of the invention herein intended.

1. A sealant solution for sealing capsules comprising a mixture of Hydroxypropylmethylcellulose (HPMC) and a solute, wherein the solute elevates the thermal gelation temperature of the HPMC, wherein the sealant solution also comprises a mixture of gelling agent and hydrolyzing agent, wherein said hydrolysing agent decreases the solution temperature of said gelling agent.

2. A solution as claimed in claim 1 wherein the grade of viscosity of the hydroxypropylmethylcellulose is 6 cps.

3. A solution as claimed in claim 1 wherein the solute which is used to elevate the thermal gelation temperature of the HPMC is an alcohol.

4. A solution as claimed in claim 3 wherein the concentration of the alcohol by weight in the solution is greater than 10%.

5. A solution as claimed in claim 3 wherein the concentration of the alcohol by weight in the solution is 20%.

6. A solution as claimed in claim 1 wherein a plasticiser such as a propylene glycol is added to modify the properties of the seal.

7. A solution as claimed in claim 1 wherein the gelling agent is comprised of one or more gums.

8. A solution as claimed claim 7 wherein the gelling agent is gellan gum.

9. A solution as claimed in claim 1 wherein the hydrolysing agent is sodium citrate.

10. A process for producing a solution for sealing capsules comprising the stages of:
(a) mixing a first subordinate solution of HPMC and alcohol to form a solution wherein the alcohol has a sufficiently high concentration by weight to elevate the thermal gelation temperature of the HPMC;
(b) mixing a second subordinate solution of gelling agent and hydrolysing agent to form a solution wherein the hydrolysing agent promotes dissolution and inhibits gelation of the gelling agent;
(c) mixing the two solutions together.

11. A process as claimed in claim 11 wherein a plasticiser such as propylene glycol is added.

12. A process as claimed in claim 11 wherein the first and second subordinate solutions are heated prior to and during mixing.

13. A process as claimed in claim 12 wherein the first and second subordinate solutions are heated to 50° C.

14. A process as claimed in claim 11 wherein the alcohol is propan-1-ol or propan-2-ol.

15. A process as claimed in claim 11 wherein the gelling agent is a gellan gum.

16. A process as claimed in claim 11 wherein the hydrolysing agent is sodium citrate.

17. A process as claimed in claim 11 wherein the concentration of alcohol in the first subordinate solution by weight is over 10%.

18. A process as claimed in claim 17 wherein the concentration of alcohol in the first subordinate solution by weight is 20%.

19. A process as claimed in claim 11 wherein the concentration of gellan gum in the second subordinate solution by weight is less than 0.5%.

20. A process as claimed in claim 19 wherein the concentration of gellan gum in the second subordinate solution by weight is 0.15%.

21. A sealant solution as claimed in claim 1 as produced by the process as claimed in claim 10.
